(19) United States
(12) Patent Application Publication
(10) Pub. No.: US 2012/0257668 A1
(43) Pub. Date: Oct. 11, 2012

(54) TIME-VARYING LEAST-MEAN-FOURTH-BASED CHANNEL EQUALIZATION METHOD AND SYSTEM

(75) Inventors: AZZEDINE ZERGUINE, DHAHRAN (SA); LAHOUARI CHEDED, DHAHRAN (SA); MUSA U. OTARU, LAGOS (NG)

(73) Assignee: KING FAHD UNIVERSITY OF PETROLEUM AND MINERALS, DHAHRAN (SA)

(21) Appl. No.: 13/084,458

(22) Filed: Apr. 11, 2011

(51) Int. Cl. H04L 27/01

(52) U.S. Cl. 375/232

(57) ABSTRACT

The time-varying least-mean-fourth-based channel equalization method is an automated procedure that provides an adaptive equalizer in a CDMA receiver. Equalizer filter coefficients are estimated using a least-mean-fourth (LMF) error calculation based on a training set of symbols sent by the transmitter. When the LMF error calculation is combined with a power-of-two quantization (PTQ) process, superior receiver performance is achieved in a time-varying CDMA channel operating in non-Gaussian noise environments.

### BACKGROUND OF THE INVENTION

1. Field of the Invention

The present invention relates to digital communications techniques for efficient data transmission over bandwidth-limited channels, and particularly to a time-varying least-mean-fourth-based channel equalization method and system that filter out non-Gaussian noise from a received signal.

2. Description of the Related Art

Adaptive equalization is vital to communication systems in order to ensure bandwidth-efficient data transmission. It has been developed during the last four decades for high-speed data transmission over bandwidth-limited channels (e.g., telephone, radio, and fiber channels) in order to ensure the integrity and the reliability of the received signals by compensating for the time dispersion introduced by the channels.

Equalization is a signal processing technique employed at the communication receiver to compensate for the disruptive effects of the channel impairments, thereby allowing a higher data transmission rate to be used. However, while alleviating these effects, care should be exercised to avoid enhancement of the unwanted noise. To effectively mitigate Inter-Symbol Interference (ISI), the transfer function of the equalizer must be a good estimate of the inverse of the channel transfer function. However, in most practical situations, the characteristics of the channel are generally unknown and time-varying, therefore making the design of equalizers that are adaptive, rather than fixed, a necessity.

The adaptive equalizer is customarily placed in the receiver and is typically implemented using an inverse filter. It is designed to approximately track and counteract the effects of any time-varying distortion. With the channel output as the source of excitation applied to the equalizer, its free parameters are continuously adjusted by means of an appropriate adaptive algorithm in order to provide an estimate of each transmitted symbol. Provision of the desired response is made locally in the receiver as part of the adaptive algorithm. The most commonly used criterion in the adaptation of the equalizer's coefficients is the minimization of the mean-square error (MSE) between the desired equalizer output (i.e., transmitted symbol) and the actual equalizer output (i.e., received symbol). This is achieved through the use of an adaptive algorithm that continuously adjusts the equalizer's parameters. The well-known Least Mean Square (LMS) algorithm is the most commonly-used adaptive algorithm because of its simplicity, ease of implementation and optimal robustness to (Gaussian) noise.

However, as pointed out above, with the increasing realization that interference signals plaguing present-day communication systems are truly of non-Gaussian nature, researchers' attention is now progressively shifting towards adaptation methods other than the LMS, since the latter's performance becomes, in this case, sub-optimal. Subsequent studies have found that higher-order non-mean-square cost functions, such as the least-mean-fourth (LMF) algorithm, have better performance in non-Gaussian environments. Unfortunately, a literature search revealed that very little consideration has so far been given to the application of this algorithm in channel equalization, partly due to its computational load.

Thus, a time-varying least-mean-fourth-based channel equalization method and system solving the aforementioned problems are desired.

### SUMMARY OF THE INVENTION

The time-varying least-mean-fourth-based channel equalization method is an automated procedure that provides an adaptive equalizer in a CDMA receiver. Equalizer filter coefficients are estimated using a least-mean-fourth (LMF) error calculation based on a training set of symbols sent by the transmitter. When the LMF error calculation is combined with a power-of-two quantization (PTQ) process, superior receiver performance is achieved in a time-varying Code Division Multiple Access (CDMA) channel operating in non-Gaussian noise environments.

These and other features of the present invention will become readily apparent upon further review of the following specification and drawings.

### BRIEF DESCRIPTION OF THE DRAWINGS

FIG. 1 is a block diagram of a baseband communication system incorporating an equalizer that may be used to implement a time-varying least-mean-fourth-based channel equalization method and system according to the present invention.

FIG. 2 is a plot showing the characteristics of LMS and LMF recursive error terms.

FIG. 3 is a plot of bit error rate vs. signal-to-noise ratio showing performance of a modified LMF algorithm at different quantization levels in the presence of Gaussian noise in a time-varying least-mean-fourth-based channel equalization method according to the present invention.

FIG. 4 is a plot of bit error rate vs. signal-to-noise ratio showing performance of a modified LMF algorithm at different quantization levels in the presence of uniform noise in a time-varying least-mean-fourth-based channel equalization method according to the present invention.

FIG. 5 is a plot of bit error rate vs. signal-to-noise ratio showing a comparison of the performance of a conventional LMF algorithm with a modified LMF algorithm in a time-varying least-mean-fourth-based channel equalization method according to the present invention at a quantization level of B=3 in the presence of near-far effect with Gaussian noise.

FIG. 6 is a plot of bit error rate vs. signal-to-noise ratio showing a comparison of the performance of a conventional LMF algorithm with a modified LMF algorithm in a time-varying least-mean-fourth-based channel equalization method according to the present invention at a quantization level of B=3 in the presence of near-far effect with uniform noise.

Similar reference characters denote corresponding features consistently throughout the attached drawings.

### DETAILED DESCRIPTION OF THE PREFERRED EMBODIMENTS

The time-varying least-mean-fourth-based channel equalization method improves the performance of an adaptive filter where there is a time-varying channel in a CDMA system operating in a non-Gaussian environment. The performance of an adaptive filter depends not only on its structure, but also on the algorithm used to recursively update the filter weights that define the structure. A number of adaptive algorithms have been developed over the years for different purposes. Notable among these algorithms is the least-mean square (LMS) algorithm, which is most commonly used in practice. Variants of the LMS algorithm, each of which serves to either improve performance or simplify implementation, have also appeared in subsequent years. Some of these variants have been applied to adaptive equalization. Despite its implementation simplicity, the LMS algorithm does not always converge desirably under non-Gaussian additive noise and when the input eigenvalue spread is large.

This has consequently motivated researchers to study non-mean-square adaptive algorithms as a viable alternative to address the problem of non-Gaussian input conditions. A large number of stochastic gradient-based non-mean square adaptive algorithms have been developed. The possibility of using higher-order algorithms, including mean-fourth and mean-sixth error cost functions, has been studied and later proposed for implementation thereof. Moreover it is generally known in the art that under the assumption of non-Gaussian noise, the least-mean-fourth algorithm (LMF) outperforms the LMS.

In order to reduce the numerical complexity and the hardware involved in the implementation of adaptive filters, methods of simplified algorithms have been explored. These methods include generally known adaptive algorithms that rely on the quantization of the coefficient updates, such as the sign-error, the sign-sign, sign-regressor, power-of-two quantizer, and dithered quantizer algorithms. Moreover, related art techniques include the successful application of a finite-bit power-of-two quantizer LMS in adaptive equalization. However, as generalized Gaussian scenarios have been considered in a number of the studies relying on the use of the conventional LMS, performance in non-Gaussian environments was degraded, as expected. Moreover, it has been shown that the LMF algorithm can outperform the LMS algorithm, even in Gaussian environments, when initialized far from the so-called “Wiener solution”, i.e., the solution for a Finite Impulse Response causal filter that includes minimization of a mean-square error (MMSE) term.

The least-mean-fourth (LMF) algorithm optimizes the criterion of the error raised to the fourth power, which has a perfect convex function of the filter coefficient vectors, and hence cannot have local minima. The algorithm has substantially less noise in the filter coefficients than the conventional LMS algorithm for the same speed of convergence (convergence being the time it takes for minimization of the error term based on a training set of symbols sent by a transmitter), except for the case when the plant measurement noise of the unknown system has a Gaussian distribution, for which case the LMS is superior to the LMF. Thus, the LMF algorithm has a better steady-state performance than the LMS algorithm for applications in which the plant noise has a short tailed probability density function.

The conventional LMF algorithm's update equation is:

w(n+1)=w(n)+2 μe³(n)x(n), (1)

where μ is the convergence parameter, e(n) is the error, w(n) represents the weight vector for the n^{th} data sample, and x(n) represents the input vector for the n^{th} data sample. Both the LMS and LMF obey the following general update equation:

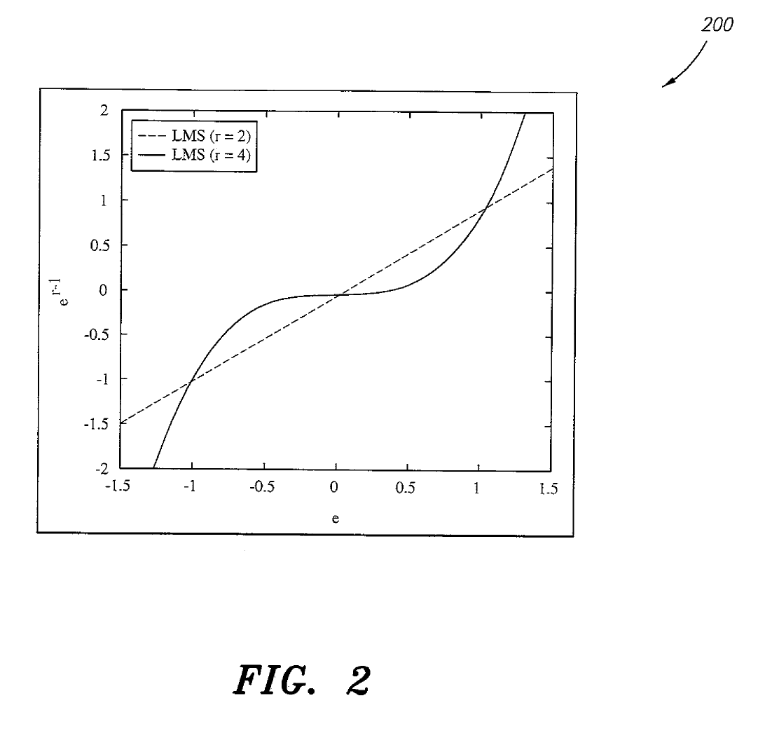

w(n+1)=w(n)+μe^{r-1}(n)x(n), (2)

where r=2 defines the LMS algorithm and r=4 defines the conventional LMF algorithm. The LMF adaptive behavior now depends on a nonlinear function of the error term. The characteristics of the recursive error term, where r=2 and r=4 represents the LMS and the conventional LMF, respectively, are shown in plot 200 of FIG. 2. As a result of the nonlinear recursive error term in the LMF algorithm, the convergence curve follows a parabolic learning curve and the convergence rate is dependent on the additive noise perturbation.

When the average error is greater than one, the LMF error magnitude is larger than for the case of the LMS algorithm, thus providing faster convergence, but also leading to the possibility of filter instability. When the algorithm is converging, the average error will be smaller, causing the LMF error magnitude to be much smaller than for the case of the LMS. Therefore, the LMF will, in this case, experience slower convergence than the LMS, but will result in a smaller residual error. Hence, the LMF algorithm has the advantage of fast initial convergence speed (when the error is greater than one) and small residual steady-state error.

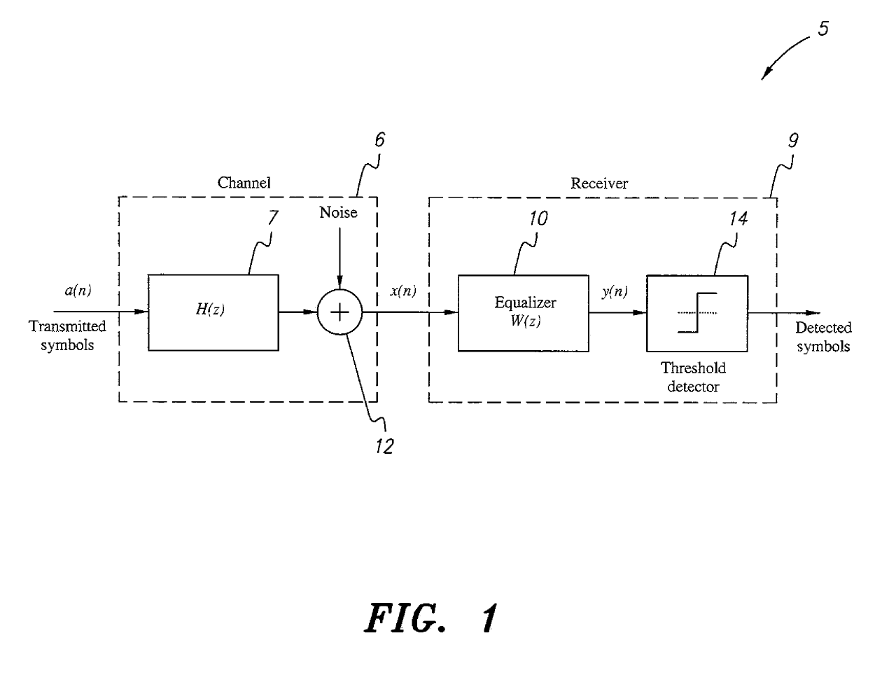

As shown in FIG. 1, in a typical baseband communication system, the receiver 9 accepts a noisy channel 6 that includes transmitted symbols a(n) input to a transfer function H(z) 7, which, by virtue of the signal-plus-noise channel characteristics 12, provides an output transmission x(n) accepted by the receiver's equalizer 10, which implements a transfer function W(z). The equalizer's output y(n) is fed to a threshold detector 14 that detects the transmitted symbols a(n). This configuration is applicable to CDMA transmitting and receiving systems.

In the present time-varying least-mean-fourth-based channel equalization method, the conventional LMF algorithm is modified by using a power-of-two quantizer to produce a modified LMF-PTQ algorithm implemented by the equalizer 10. In the present method, modification of the equalizer coefficient update of equation (2) results in:

w(n+1)=w(n)+2 μq[e³(n)]sgn[x(n)], (3)

where q[e³(n)] is the modified power-of-two quantizer and is defined by:

$$q [ {e}^{3} ( n ) ] = \{ \begin{matrix}sgn [ e ( n ) ] & \vert e ( n ) \vert \geq 1 \\ {2}^{⌊ 3 ln \vert e ( n ) \vert ⌋} sgn [ e ( n ) ] & {2}^{\frac{- B + 1}{3}} \leq e ( n ) < 1 \\ 0 & \vert e ( n ) \vert < {2}^{\frac{- B + 1}{3}}\end{matrix} \qquad ( 4 )$$

In the CDMA system used here, the pseudonoise (PN) code, with length L_{c}=16, consists of a sequence of binary pulses of values±1 that are transmitted at the chip rate 1/T_{c}. The channel estimation is carried out by transmitting ten pilot bits. Here, the transmission is over a flat fading channel with orthogonal PN codes. Let sₖ(n) denote the n^{th} term of the PN sequence associated with user k, so that:

sₖ(n)=±1,0≦n<Lₓ, (5)

where the index n is used to denote time in the chip-rate domain. Collecting the L_{c} samples {sₖ(•)} into a vector gives:

sₖ=col{sₖ(0),sₖ(1), . . . ,sₖ(L_{c}−1)}. (6)

Ideally, the PN codes of different users are orthogonal to each other, i.e., they satisfy:

$${ρ}_{kj} {=}^{Δ} {s}_{k}^{T} {s}_{j} = \{ \begin{matrix}{L}_{c} , & if k = j , \\ 0 , & otherwise .\end{matrix} \qquad ( 7 )$$

When the orthogonality condition fails, the codes become correlated.

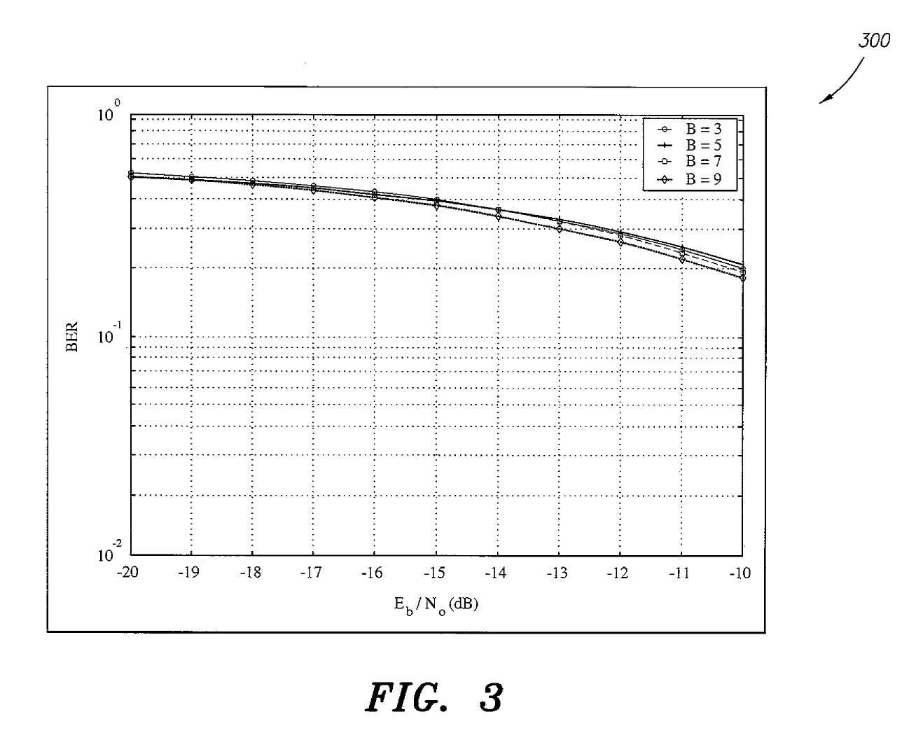

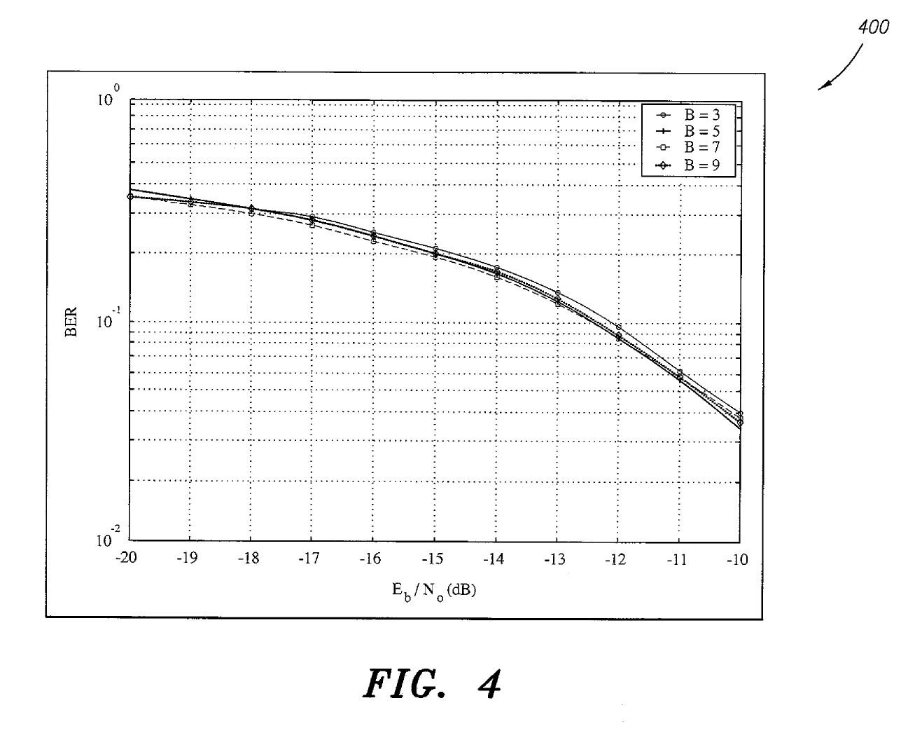

In an exemplary simulation where the transmission is over a flat, fading channel with orthogonal PN codes, and there are two users having transmissions that are synchronized with each other, where both users are kept at the same distance from the receiver, and also they are transmitting at the same power level, the results are shown in plots 300 and 400 of FIGS. 3 and 4, respectively. The performance of the LMF-PTQ algorithm for different values of B in the presence of Gaussian noise, as shown in plot 300, and in the presence of uniform noise, as shown in plot 400, reveals that the performance of the LMF-PTQ algorithm remains almost unchanged for different values of B and for the same type of noise. However, it is clear from FIG. 4 that the performance of the proposed LMF-PTQ algorithm is far better in a uniform noise environment than it is in a Gaussian noise one.

The LMF-PTQ algorithm performance was also evaluated during the presence of a near-far effect. Here, the transmission is done over a flat, fading channel with orthogonal PN codes. The number of users considered here are two. In the simulation, both users are kept at the same distance from the receiver, but are transmitting data at different power levels in order to mimic the near-far effect. Data are transmitted by users at the bit rate 1/T_{b}, which is much slower than the chip rate 1/T_{c}. For each user, the data bit is first multiplied by the corresponding PN sequence prior to transmission through the channel.

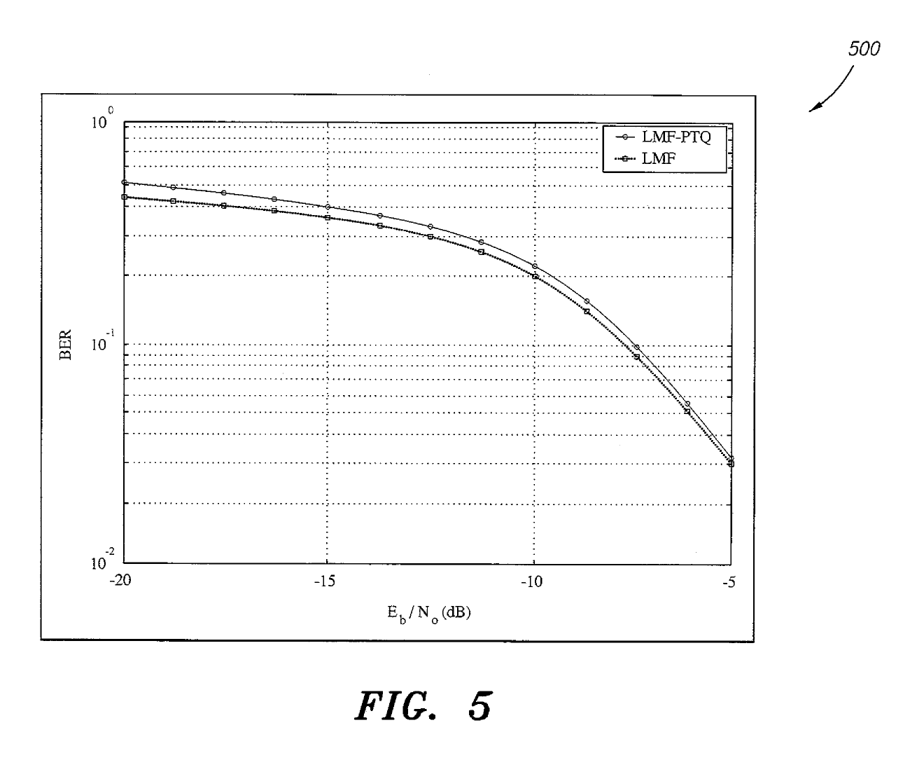

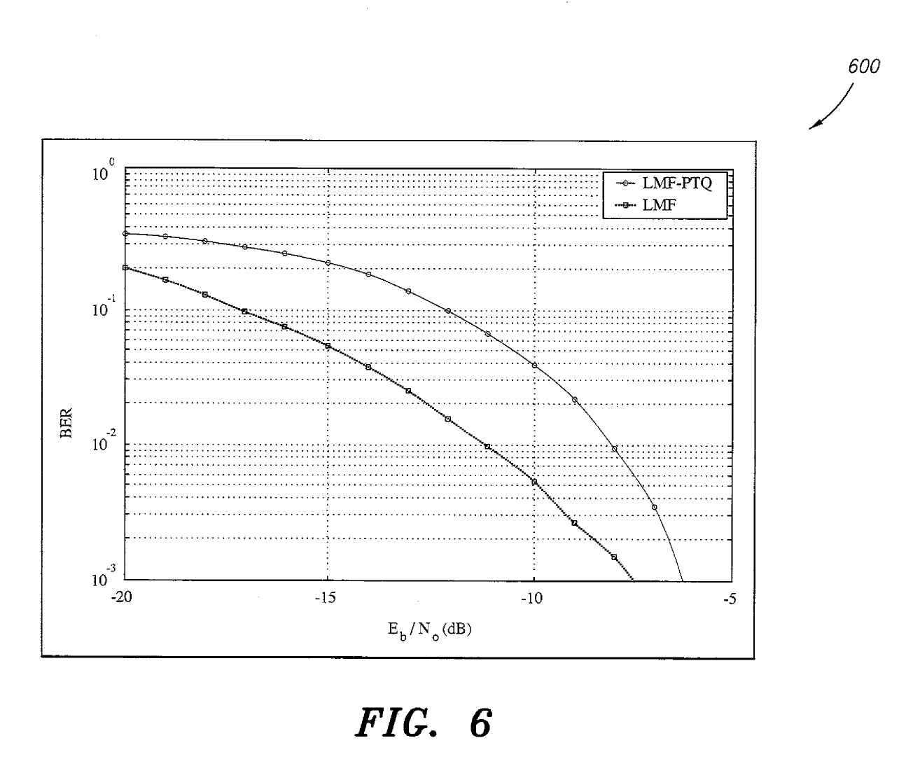

The results in plots 500 and 600 of FIGS. 5 and 6, respectively, obtained for a coarse quantization level of B=3, show the performance of the LMF-PTQ algorithm in the presence of near-far effect under both Gaussian and uniform noise scenarios, respectively. As can be seen from FIG. 5 no deterioration in performance is observed between the two algorithms for the case of Gaussian noise. However, the LMF algorithm performs better than the LMF-PTQ algorithm for the case of uniform noise. With reference to FIG. 6 it is clear that as the quantization fineness increases, i.e., as B gets larger, the performance of the LMF-PTQ approaches that of the unquantized LMF algorithm.

With reference to both figures, the LMF algorithm performs much better for the uniform noise case than it does for the Gaussian. This is due to the well-known fact that the LMF is better suited for non-Gaussian environments than it is for Gaussian ones.

The time-varying least-mean-fourth-based channel equalization method focuses on a realistic application illustrated by a time-varying channel in a CDMA system that operates in a non-Gaussian environment. Such an application offers two important challenges that have to be overcome in practice if data transmission is not to suffer from the deleterious effects of a time-variation-induced signal dispersion and computational load-induced transmission delay and cost. The simulation study shows the superior performance of the LMF-PTQ algorithm in a non-Gaussian (uniform) noise environment to its own performance in a Gaussian one. Moreover, the study also shows that this excellent performance is maintained even at a quantization resolution as low as 3 bits, which greatly lowers both its structural complexity and implementation cost. Simulation results also demonstrate the very good performance of the LMF-PTQ algorithm in combating the near-far effects on data transmission over a flat, fading channel, even with a coarse quantization of 3 bits. This performance is also shown to improve with higher quantization resolutions.

It will be understood that the diagrams in the drawings depicting the time-varying least-mean-fourth-based channel equalization method are exemplary only, and may be embodied in a dedicated electronic device having a microprocessor, microcontroller, digital signal processor, application specific integrated circuit, field programmable gate array, any combination of the aforementioned devices, or other device that combines the functionality of the time-varying least-mean-fourth-based channel equalization method onto a single chip or multiple chips programmed to carry out the method steps described herein, or may be embodied in a general purpose computer having the appropriate peripherals attached thereto and software stored on a computer-readable media that can be loaded into main memory and executed by a processing unit to carry out the functionality of the system and steps of the method described herein.

It is to be understood that the present invention is not limited to the embodiments described above, but encompasses any and all embodiments within the scope of the following claims.

We claim:

1. A time-varying least-mean-fourth-based channel equalization system, comprising:
means for digitally receiving CDMA encoded symbols transmitted over at least one time-varying channel;
an equalizer including an adaptive filter having weighted coefficients, the equalizer accepting the at least one time-varying channel as input and providing an equalized, noise cancelled output of the at least one time-varying channel, the equalizer having:
means for calculating a least-mean-fourth error associated with a comparison of the adaptive filter equalizer's output versus a transmitted training set of the CDMA encoded symbols;
a power-of-two quantizer;
means for combining the power-of-two quantizer with the means for calculating the least-mean-fourth error; and
means for recursively updating the adaptive filter weighted coefficients based on an output of the means for combining the power-of-two quantizer with the means for calculating the least-mean-fourth error; and
a threshold detector accepting the adaptive filter equalizer output and providing a threshold detector output including the transmitted CDMA encoded symbols detected by the equalizer.

2. The time-varying least-mean-fourth-based channel equalization system according to claim 1, wherein said training symbols comprise a transmission of ten pilot bits.

3. The time-varying least-mean-fourth-based channel equalization system according to claim 1, wherein said equalizer coefficient update means further comprises means for calculating the relation,
w(n+1)=w(n)+2 μq[e³(n)]sgn[x(n)],
where q[e³(n)] is the modified power-of-two quantizer and is defined by the relation:
$$q [ {e}^{3} ( n ) ] = \{ \begin{matrix}sgn [ e ( n ) ] & \vert e ( n ) \vert \geq 1 \\ {2}^{⌊ 3 ln \vert e ( n ) \vert ⌋} sgn [ e ( n ) ] & {2}^{\frac{- B + 1}{3}} \leq e ( n ) < 1 \\ 0 & \vert e ( n ) \vert < {2}^{\frac{- B + 1}{3}}\end{matrix}$$
where B is the level of quantization.

4. A computer-implemented time-varying least-mean-fourth-based channel equalization method, comprising the steps of:
digitally receiving CDMA encoded symbols transmitted over at least one time-varying channel;
equalizing the at least one time-varying channel as input and providing an equalized, noise-cancelled output of the at least one time-varying channel, the equalizing step including synthesis of an adaptive filter having weighted filter coefficients;
calculating a least-mean-fourth error associated with a comparison of an output of the equalization step versus a transmitted training set of the CDMA encoded symbols;
power-of-two quantizing the at least one time-varying channel;
combining the power-of-two quantization with the least-mean-fourth error calculation;
recursively updating the adaptive filter weighted coefficients based on an output of the step of combining the power-of-two quantization with the least-mean-fourth error calculation; and
threshold detecting the noise-cancelled output of the at least one time-varying channel, thereby providing the transmitted CDMA encoded symbols detected by the equalizer.

5. The time-varying least-mean-fourth-based channel equalization method according to claim 4, further comprising the step of accepting a transmission of ten pilot bits to be used as the training symbols.

6. The time-varying least-mean-fourth-based channel equalization method according to claim 4, further comprising the step of utilizing at least one PN code having length L_{c}=16, the at least one PN code consisting of a sequence of binary pulses of values±1 transmitted at a chip rate 1/T_{c}, the at least one PN code being associated with the at least one time-varying channel.

7. The time-varying least-mean-fourth-based channel equalization method according to claim 4, wherein said equalizer coefficient updating step further comprises the step of calculating the relation,
w(n+1)=w(n)+2 μq[e³(n)]sgn[x(n)],
where q[e³(n)] is the modified power-of-two quantizer and is defined by the relation,
$$q [ {e}^{3} ( n ) ] = \{ \begin{matrix}sgn [ e ( n ) ] & \vert e ( n ) \vert \geq 1 \\ {2}^{⌊ 3 ln \vert e ( n ) \vert ⌋} sgn [ e ( n ) ] & {2}^{\frac{- B + 1}{3}} \leq e ( n ) < 1 \\ 0 & \vert e ( n ) \vert < {2}^{\frac{- B + 1}{3}}\end{matrix}$$
where B is the level of quantization.

8. A computer software product, comprising a medium readable by a processor, the medium having stored thereon a set of instructions for performing a time-varying least-mean-fourth-based channel equalization method, the set of instructions including:
(a) a first sequence of instructions which, when executed by the processor, causes said processor to digitally receive CDMA encoded symbols transmitted over at least one time-varying channel;
(b) a second sequence of instructions which, when executed by the processor, causes said processor to equalize said at least one time-varying channel as input and provide an equalized, noise-cancelled output of the at least one time-varying channel, the equalization including the synthesis of an adaptive filter having weighted filter coefficients;
(c) a third sequence of instructions which, when executed by the processor, causes said processor to calculate a least-mean-fourth error associated with a comparison of an output of the equalization versus a transmitted training set of the CDMA encoded symbols;
(d) a fourth sequence of instructions which, when executed by the processor, causes said processor to perform a power-of-two quantization of the at least one time-varying channel;
(e) a fifth sequence of instructions which, when executed by the processor, causes said processor to combine the power-of-two quantization with the least-mean-fourth error calculation;
(f) a sixth sequence of instructions which, when executed by the processor, causes said processor to recursively update the adaptive filter weighted coefficients based on an output of combining the power-of-two-quantization with the least-mean-fourth error calculation; and
(g) a seventh sequence of instructions which, when executed by the processor, causes said processor to threshold detect the noise-cancelled output of the at least one time-varying channel, thereby providing the transmitted CDMA symbols detected.

9. The computer software product according to claim 8, further comprising an eighth sequence of instructions which, when executed by the processor, causes said processor to accept a transmission of ten pilot bits to be used as the training symbols.

10. The computer software product according to claim 8, further comprising a ninth sequence of instructions which, when executed by the processor, causes said processor to calculate, as a part of the equalizer coefficient updating, the relation:
w(n+1)=w(n)+2 μq[e³(n)]sgn[x(n)],
where q[e³(n)] is the modified power-of-two quantizer and is defined by the relation,
$$q [ {e}^{3} ( n ) ] = \{ \begin{matrix}sgn [ e ( n ) ] & \vert e ( n ) \vert \geq 1 \\ {2}^{⌊ 3 ln \vert e ( n ) \vert ⌋} sgn [ e ( n ) ] & {2}^{\frac{- B + 1}{3}} \leq e ( n ) < 1 \\ 0 & \vert e ( n ) \vert < {2}^{\frac{- B + 1}{3}}\end{matrix}$$
where B is the level of quantization.

11. The computer software product according to claim 8, further comprising a tenth sequence of instructions which, when executed by the processor, causes said processor to utilize a coarse quantization of 3 binary digits.

12. The computer software product according to claim 8, further comprising an eleventh sequence of instructions which, when executed by the processor, causes said processor to utilize a quantization of greater than 3 binary digits.
